(19) United States
(12) Patent Application Publication
(10) Pub. No.: US 2008/0022871 A1
(43) Pub. Date: Jan. 31, 2008

(54) Foil Transfer Unit Having a Material Application Device

(75) Inventors: Alexander Weber, Weinheim (DE); Rudi Sauer, Rauenberg (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 11/830,919

(22) Filed: Jul. 31, 2007

(30) Foreign Application Priority Data
Jul. 31, 2006 (DE) 102006035299.8
Aug. 18, 2006 (DE) 102006038798.8

(51) Int. Cl. B41F 7/26; B41F 13/08

(52) U.S. Cl. 101/217; 101/375; 101/492

(57) ABSTRACT

An apparatus, a method and a transfer foil for transferring a transfer layer onto a printing material in a transfer unit. In order to avoid the adhesion, and simultaneously retain the flexibility of the transfer cylinder, it is proposed that the transfer unit has at least one material application device for applying friction-reducing material onto the transfer cylinder and/or the carrier foil reverse side. Furthermore, a transfer foil is proposed, the carrier foil of which has a rear-side coating of friction-reducing material. The friction-reducing material may be a fluid or powder.

### CROSS-REFERENCE TO RELATED APPLICATIONS

This application claims the priority, under 35 U.S.C. § 119, of German applications DE 10 2006 035 299.8, filed Jul. 31, 2006, and DE 10 2006 038 798.8, filed Aug. 18, 2006; the prior applications are herewith incorporated by reference in their entirety.

### BACKGROUND OF THE INVENTION

### Field of the Invention

The present invention relates to an apparatus for transferring a transfer layer from the front side of a carrier foil, which together form a transfer foil, onto a printing material. The apparatus comprises at least one transfer unit for transferring the transfer layer onto the printing material, the transfer unit comprising at least one transfer cylinder for transferring the transfer layer.

Furthermore, the invention relates to a method for transferring a transfer layer from the front side of a carrier foil, which together form a transfer foil, onto a printing material, the transfer foil being fed to a transfer cylinder for transferring, and the transfer layer being transferred onto the printing material by being detached in regions from the carrier foil.

Furthermore, the invention relates to a transfer foil for use in a transfer method, comprising a carrier foil, to the front side of which a release layer is applied which carries a transfer layer which is transferred from the transfer foil onto a printing material.

The invention preferably relates to an apparatus, a method and a transfer foil, which is suitable for so-called cold foil transfer.

In cold foil transfer, a transfer layer is transferred from a carrier material onto a printing material.

A carrier foil is used as carrier material. A varnish layer is applied to this carrier foil, which varnish layer is responsible, in particular, for coloring the transfer layer. An aluminum layer which brings about the metallic gloss of the transfer layer is connected to the varnish layer. Furthermore, a further adhesive layer which improves the adhesion properties of the transfer layer with the adhesive on the printing material can also be provided on the aluminum layer. The layers which are transferred by the carrier material are together denoted as transfer layer.

In order to transfer the transfer layer onto a printing material, the transfer foil is guided together with the printing material through a transfer nip. The transfer nip is formed by a transfer cylinder and an impression cylinder which bear against one another. The transfer cylinder and the impression cylinder are thrown onto one another in a rotating manner with a force, with the result that the transfer layer is transferred onto the printing material in the transfer nip.

In order that the transfer layer can be transferred in regions onto the printing material, the printing material, for example, is provided, before the foil transfer, with an adhesive layer which corresponds to the region, in which foil is transferred.

A colorless adhesive, an adhesive having a defined inherent color or else an adhesive which is colored in accordance with the foil can be used as adhesive. It is already known from bronzing technology to use a particularly tacky ink for transferring metal particles, the coloration of which tacky ink corresponds to the desired metalization. To this extent, the tacky ink can naturally also be used as an alternative to the colored adhesive.

The transfer layer can be substantially a metal layer or else other layers. For example, an aluminum layer can be provided which is applied depending on requirements to a yellow/golden varnish layer or a silver varnish layer.

Furthermore, a colorless layer, for example from PE foil, can also be used as transfer layer, which is transferred onto the printing material in such a way that it forms a protective layer there.

The use of a conductive layer as transfer layer is also possible; as a result, electrically and/or thermally conductive regions can be transferred onto the printing material. The transfer of prepared detached layer regions as transfer layer is also possible; here, these can be, for example, RFID chips (radio frequency identification chips) or their antennas. Suitable ceramics can also be transferred. It is conceivable in this way that superconducting structures can also be transferred onto a printing material.

An apparatus for cold foil transfer is proposed in European patent EP 0 578 706 B1, and its counterparts U.S. Pat. Nos. 5,735,994 and 5,565,054.

There, the cold foil transfer takes place within a multiple color printing press. The printing material is transported along a predefined transport path in the printing press. The printing material can be, for example, paper sheets, paperboard or else webs.

In a first printing unit of the printing press, an adhesive is transferred onto the printing material instead of an ink. For application of the adhesive in regions, a printing plate having correspondingly set images is clamped in this printing unit and the adhesive is transferred onto the printing material like a conventional offset printing ink. A printing unit of this type which applies adhesive is called an application unit.

The printing material is then transported further into a second printing unit. In this second printing unit, the impression cylinder and the blanket cylinder are configured as transfer unit.

A foil module having a transfer foil supply shaft and a transfer foil collecting shaft is situated in the region of this second printing unit. The foil is guided as transfer foil web over intermediate rollers of a foil guiding device from the transfer foil supply shaft to the transfer nip and further to the transfer foil collecting shaft.

In order to transfer the transfer layer onto the printing material, the transfer foil web and the printing material with the adhesive layer in regions are guided together along their respective transport paths through the transfer nip in such a way that the transfer layer rests on the adhesive layer. The transfer layer is then transferred onto the printing material in the transfer nip by way of pressure. Here, the transfer layer is removed cleanly from the transfer foil as a result of the adhesive.

For a clean transfer of the transfer layer onto the printing material, the foil and the printing material are driven at the same speed in the region of the transfer nip during the transfer.

In a following press unit, pressure is then exerted substantially onto the transferred transfer layer, with the result that permanency of the foil deposit is achieved.

Here, the moment, at which the transfer layer is detached from the carrier foil, is to be seen as a particularly sensitive step during the transfer of the transfer layer onto the printing material. This detachment and also the further transport of the carrier foil can be at least disrupted by adhesion of the carrier foil on the transfer cylinder. Therefore, there is also provision in the above-mentioned European patent EP 0 578 706 B1 for a possibly elastic impression roll with a smooth surface to be used as transfer cylinder. However, there are still adhesion forces here between the transfer cylinder and the transfer foil.

In order to reduce this adhesion force between the carrier foil and the transfer cylinder, it has been proposed in international PCT publication WO 2005/100025 A1 to provide the transfer cylinder with a low-friction covering which has a structure in the form of spherical caps, such as a known glass bead cloth. As a result of the use of a glass bead cloth of this type as transfer cylinder or as surface of the transfer cylinder, the frictional force between the transfer cylinder and the carrier foil can be at least reduced.

A problem of the solution which is described here is that this surface structure of the transfer cylinder is also embossed onto the printing material which is to be coated. This is not always necessarily desired. If a conventional printing unit of a printing press is used as transfer unit for transferring the transfer layer onto the printing material, a blanket cylinder of the printing unit, for example, is set up as transfer cylinder. However, no glass bead cloth can be used as surface of this blanket cylinder during a printing operation. It is therefore necessary to exchange the surface of the blanket cylinder for the previously known solution, in order to reduce the friction. For this purpose, the rubber blanket of the blanket cylinder used in offset operation is exchanged for a corresponding glass bead cloth.

### SUMMARY OF THE INVENTION

It is then the object of the present invention to propose an apparatus, a method and a transfer foil of the generic type which is mentioned in the introduction, which at least reduces the depicted problem of friction between the transfer cylinder and the carrier foil, without further limiting the flexibility of the transfer unit in the process and simultaneously achieving as high a quality as possible of the resulting printed product.

With the above and other objects in view there is provided, in accordance with the invention, an apparatus for transferring a transfer layer from a front side of a carrier foil onto a printing material, the carrier foil and the transfer layer together forming a transfer foil. The apparatus comprises:

at least one transfer unit for transferring the transfer layer onto the printing material; the transfer unit including at least one transfer cylinder for transferring the transfer layer; and

the transfer unit including at least one material application device disposed to apply friction-reducing material onto at least one of the transfer cylinder and a reverse side of the carrier foil.

With the above and other objects in view there is also provided, in accordance with the invention, a method of transferring a transfer layer from a front side of a carrier foil onto a printing material, the carrier foil and the transfer layer together forming a transfer foil. The method comprises:

feeding the transfer foil to a transfer cylinder;

applying a friction-reducing material for reducing an adhesion between the carrier foil and a surface of the transfer cylinder to at least one of a rear side of the carrier foil and the surface of the transfer cylinder; and

transferring sections of the transfer layer onto the printing material by detaching the transfer layer in sections from the carrier foil.

In order to reduce the friction between the carrier foil and the transfer cylinder, that is to say in order to reduce the adhesion of the carrier foil on the transfer cylinder, there is provision for the transfer unit to comprise at least one material application device for applying friction-reducing material onto the transfer cylinder and/or the carrier foil reverse side. By means of this material application device, the corresponding material can then be applied to the surface of the transfer cylinder, that is to say to the transfer cylinder surface or the reverse side of the carrier foil. The adhesion of the carrier foil on the transfer cylinder can likewise be at least reduced by a transfer foil which has a rear-side coating made from a corresponding friction-reducing material.

For example, PTFE (polytetrafluoroethylene), that is to say Teflon®, or a powder coating can be provided as the friction-reducing material on the rear side of the carrier foil.

According to the invention, the material application device can be provided in the region of the transfer cylinder, in order to apply the friction-reducing material to the surface of the transfer cylinder directly. In an alternative embodiment, there can be provision for the material application device to be provided in the region of the transport path of the transfer foil, the friction-reducing material then being applied directly to the rear side of the transfer foil. This is expedient particularly in a position, where the transfer layer of the transfer foil has not yet been transferred onto the printing material by the transfer cylinder. This transfer can take place, for example, in a transfer nip which is formed by the transfer cylinder and an impression cylinder.

In order to increase the flexibility of a corresponding transfer unit and to make retrofitting possible of transfer units which already exist, there is provision according to the invention in one particularly advantageous embodiment for the material application device to be set up in the manner of a cassette which can be removed from the transfer unit.

In one embodiment according to the invention, there is provision for the friction-reducing material to be applied to the transfer cylinder surface and/or the carrier foil reverse side by means of brushing on, spraying on, rolling on, doctoring on or by way of a cloth. For this purpose, there is accordingly provision according to the invention for the material application device to have either a brush, a cloth, an inflating element for inflating the material, a doctor or a corresponding roll. In particular, however, there can also be provision for the material to be applied to the carrier foil reverse side and/or the transfer cylinder surface by means of a combination of these elements.

In order to prevent the friction-reducing material from passing into other positions within a printing press or a corresponding transfer unit, where damage can be caused or the quality of a printed product could suffer from this material, there is provision in one advantageous embodiment for air which is contaminated with friction-reducing material to be extracted from the region of the application of the material. A corresponding extraction element is provided for this purpose.

There is particularly preferably provision for the transfer unit to be a printing unit of a printing press which already exists and for a corresponding blanket cylinder of a printing unit to be used as transfer cylinder. This achieves a use of the printing unit or the transfer unit which is as flexible as possible. It can then also be used, for example, for printing the printing material by means of ink, instead of use for transferring the transfer layer onto a printing material. In particular, there is therefore provision for it to be possible for the transfer unit to be a printing unit, a varnishing unit or a modular unit of a printing press.

In order to provide the transfer cylinder with a largely intact surface, and in order to increase the flexibility of the transfer cylinder, with the result that it can also be used for other processes, such as for printing materials, after the transfer operation, a washing device for washing the transfer cylinder surface is advantageously provided according to the invention. By means of the washing device, the transfer cylinder surface can be cleaned of residues of the friction-reducing material. This washing device can be, in particular, a rubber blanket washing device. This can then advantageously be a rubber blanket washing device which has already been provided in the region of the transfer cylinder or the blanket cylinder.

In order for it then to be possible for this rubber blanket washing device to be used as flexibly as possible, that is to say both for cleaning the transfer cylinder surface of residues of the friction-reducing material and also of ink residues during an offset printing process, there is advantageously provision for the rubber blanket washing device to have at least two washing agent circuits for at least one first washing agent for cleaning the transfer cylinder surface of residues of the friction-reducing material and for a second washing agent for cleaning the transfer cylinder surface of ink residues of an offset printing process. In method terms, there is accordingly provision for the transfer cylinder surface to be cleaned of the corresponding residues of the friction-reducing material by means of the first washing agent and of ink residues by means of the second washing agent.

In further embodiments according to the invention, the transfer cylinder is a blanket cylinder, and a plate cylinder which is thrown onto the blanket cylinder for possible offset printing is provided without printing plates or in the thrown-off position from the blanket cylinder. This advantageously achieves a situation where a gap exists between the blanket cylinder and the plate cylinder. The friction-reducing material cannot then pass from the surface of the transfer cylinder or the blanket cylinder onto the plate cylinder and, via this, into an inking unit which is possibly present. The same is true for other rollers or cylinders which are thrown onto a transfer cylinder of the transfer unit, such as rollers in a varnishing unit, as a result of which it is prevented that the friction-reducing material passes into a corresponding circuit, in which it is undesirable.

Here, in particular in method terms, there can advantageously be provision for the plate cylinder to be set up in such a way that it is provided in a contactless manner with respect to the blanket cylinder at least during the method for transferring the transfer layer onto the printing material. This can advantageously be effected in such a way that the plate cylinder is actively thrown off the blanket cylinder or, vice versa, the blanket cylinder is moved away from the plate cylinder. In general, it is advantageously sufficient to provide the plate cylinder without plates, that is to say without a printing plate which is fastened to it. It is also thus possible for a correspondingly sufficient gap to be achieved between the plate cylinder and the blanket cylinder.

In particularly advantageous embodiments of the apparatus, there is provision for the friction-reducing material to be a material of the group comprising fluids and powders. Accordingly, there can be provision for silicone oil to be provided as fluid or for a mineral or organic powder or else French chalk to be provided as friction-reducing material. If powder is used as friction-reducing material, there can be provision, in particular, for the material application device to be a powdering device of a printing press. As a result, technologies which already exist can be used.

It has proved particularly favorable to use powder having a grain size between 10 and 90 μm, in order to reduce the friction between the carrier foil and the transfer cylinder. Here, a grain size of from 15 to 35 μm has proved particularly preferable.

With the above and other objects in view there is also provided, in accordance with the invention, a transfer foil, comprising:

a carrier foil having a front side and a rear side;

a release layer applied to the front side of the carrier foil, and a transfer layer carried on the release layer; and

a coating of friction-reducing material applied on the rear side of the carrier foil;

wherein the carrier foil and the transfer layer are configured for a transfer method in which the transfer layer, or segments thereof, is transferred from the carrier foil onto a printing material.

In other words, in one development of the transfer foil, there is provision for an additional layer comprising an adhesion promoter to be applied to the transfer layer which can comprise, for example, a metal layer. The adhesion promoter can then produce a contacting connection with the adhesive layer on the printing material and therefore assist the transfer of the transfer layer to the printing material in an even more improved manner.

The advantages which are described here of the apparatus, the method and the transfer foil are also valid for combinations of the individual features which are not specified here, but are conceivable in the field of possible embodiments for a person skilled in the art.

Once more in summary, the invention provides for an apparatus, a method and a transfer foil for transferring a transfer layer onto a printing material in a transfer unit.

This detaching and also the further transport of the carrier foil which carries the transfer layer can be at least disrupted by adhesion of the carrier foil on a transfer cylinder.

Solutions are known from the prior art, which lead to impressed portions in the transfer layer or the printing material, make flexible use difficult of the transfer cylinder, for example as blanket cylinder in a printing unit, or do not suppress adhesion sufficiently.

In order to avoid the adhesion with simultaneous retention of the flexibility of the transfer cylinder, it is proposed that the transfer unit comprises at least one material application device for applying friction-reducing material onto the transfer cylinder and/or the carrier foil reverse side. Furthermore, a transfer foil is proposed, the carrier foil of which has a rear-side coating of friction-reducing material.

Other features which are considered as characteristic for the invention are set forth in the appended claims.

Although the invention is illustrated and described herein as embodied in foil transfer unit having a material application device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic side view of a transfer unit having a material application device on the transfer cylinder;

FIG. 2 is a similar view of a transfer unit having a material application device on the transport path of the transfer foil; and

FIG. 3 is a sectional view taken through the structure of a transfer foil having an antiadhesion layer.

### DETAILED DESCRIPTION OF THE INVENTION

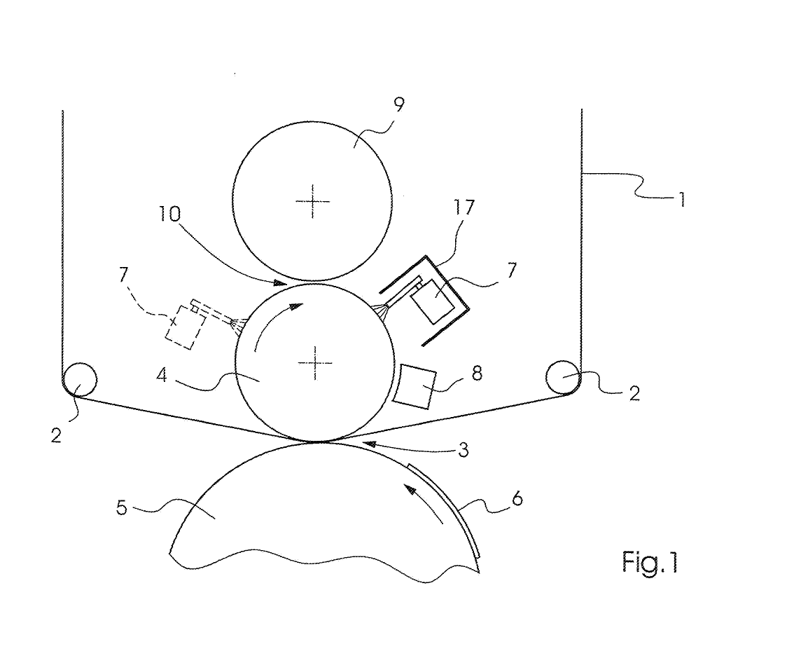

Referring now to the figures of the drawing in detail and first, particularly, to FIG. 1 thereof, there is shown a transfer unit for transferring a transfer layer onto a sheet 6. As is intended to be shown here, this transfer unit can be a printing unit of a printing press.

A transfer foil 1 is unwound from a foil supply roller and is guided around deflection rollers 2 along a transport path to a transfer nip 3. The transfer nip 3 is formed by an impression cylinder 5 and a blanket cylinder 4 which serves here as transfer cylinder. After it has passed through the transfer nip 3, the transfer foil 1 is fed back via a deflection roller 2 to a foil collecting roller.

A sheet 6 is likewise guided through the transfer nip 3 along a dedicated transport path. An adhesive layer in regions which has been applied to the sheet 6 in an application unit (disposed upstream, not illustrated) is situated on the sheet 6. The sheet 6 is then guided together with the transfer foil 1 through the transfer nip 3, and the transfer layer 12 of the transfer foil 1 is transferred to those regions of the sheet 6 which are coated with adhesive as a result of the contact pressure between the blanket cylinder 4 and the impression cylinder 5. Here, the transfer layer 12 is removed from the transfer foil 1 in the transfer nip 3.

In order to avoid adhesion of the transfer foil 1 on the blanket cylinder 4, a friction-reducing material is applied via a material application device 7 to the blanket cylinder 4, that is to say to its surface. This friction-reducing material can be, for example, French chalk powder. It can also be a fluid, such as silicone oil, or a powder, as is preferred. This can be, for example, a mineral powder having a type designation KSL-K2 or an organic powder having the type designation KSL-S5 of the company KSL-Staubtechnik GmbH. Overall, it is desirable that the powder have grain sizes between 10 and 90 μm here, grain sizes in the range between 15 and 35 μm being preferred particularly.

Here, a powdering device such as has been described, for example, in German patent DE 197 51 383 B4 (cf. U.S. Pat. No. 6,413,580 B1) for the application of powder onto a sheet can be used as the material application device 7. The prior disclosures are herewith incorporated by reference.

As it is a printing unit which is used as transfer unit in the case which is described here, a plate cylinder 9 is situated in the vicinity of the blanket cylinder 4. This plate cylinder 9 is either thrown off the blanket cylinder 4 or there is an intermediate space 10 between the printing plate cylinder 9 and the blanket cylinder 4 as a result of a printing plate not being used, that is to say no printing plate is clamped onto the printing plate cylinder 9. That is to say, the powder or in general the friction-reducing material which is applied via the material application device 7 cannot be transferred to the plate cylinder 9 by the blanket cylinder 4. It cannot therefore also pass into a dampening unit or inking unit of the printing unit. It is therefore also possible to provide the material application device 7 either in front of or after the intermediate space 10 in the circumferential direction of the blanket cylinder 4. Here, a corresponding position of the material application device 7 in front of the intermediate space 10 is shown with dashed lines.

In a further method, the printing unit which is shown here can also be used as a normal printing unit and not as a transfer unit. For this purpose, it is firstly necessary that no transfer foil 1 is guided through the transfer nip 3. This can be achieved by the transfer foil 1 being removed from the transfer unit. In order that no powder or no friction-reducing material can pass into the inking units or dampening units of the printing unit, it is necessary that the blanket cylinder is freed of residues of the friction-reducing material before the printing unit is started. This can take place via a washing device. In this case, a rubber blanket washing device 8 is provided which is provided at any desired location of the blanket cylinder 4. This rubber blanket washing device 8 can act, for example, via brushes or compressed air or via a cloth which acts on the surface of the blanket cylinder. Corresponding rubber blanket washing devices are disclosed, for example, in the European patents EP 715 956 B1 and EP 291 745 B1 (U.S. Pat. No. 4,867,064), and in German published patent application DE 102 44 218 A1 (cf. U.S. Pat. No. 6,732,652 B2). These documents are herewith incorporated by reference in their entirety, concerning the disclosures in relation to the embodiments of rubber blanket washing devices.

Furthermore, in order to prevent a corresponding friction-reducing material or powder passing into other regions of the printing press or the printing unit, an extraction device 17 is additionally provided here around the material application device 7. This extraction device 17 is shown only for one material application device 7, but can be provided in principle and should also be provided preferably in every possible position of the material application device 7.

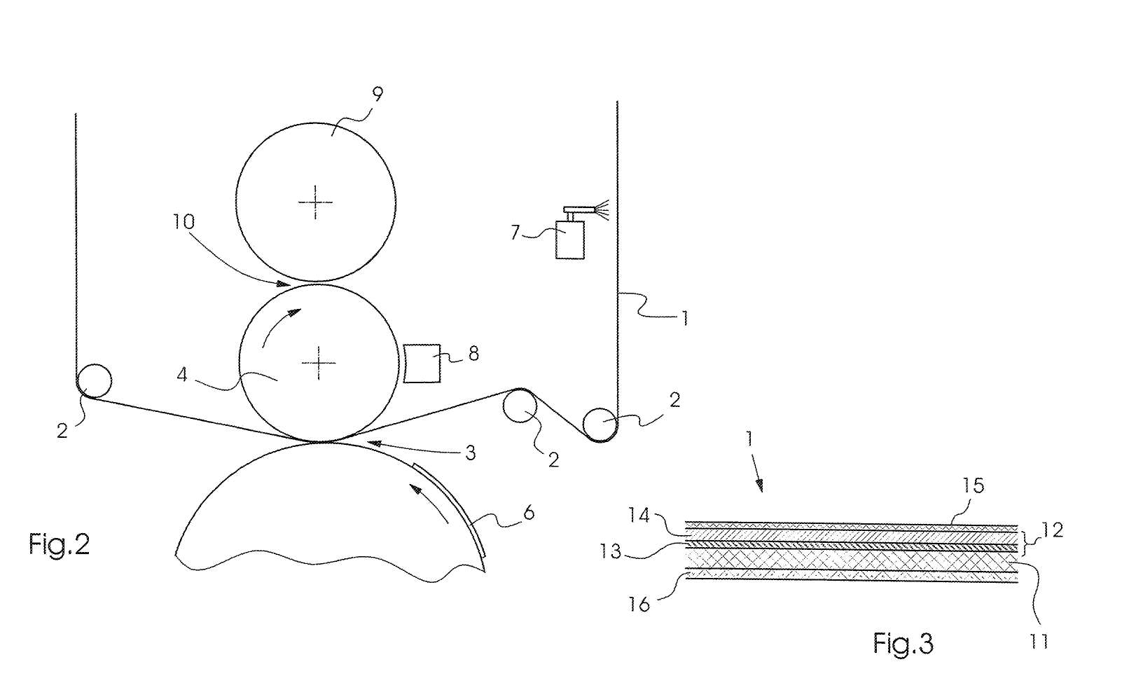

FIG. 2 shows one alternative position of the material application device 7, the remaining elements corresponding substantially to those of FIG. 1. Identical elements are denoted here with identical designations.

In the case which is shown here, the carrier foil 1 is guided over two deflection rollers 2 for passage through the transfer nip 3. This is therefore naturally also possible for the case which is shown in FIG. 1. Overall, a very wide variety of guide means are possible for the carrier foil 1.

In the case which is shown in FIG. 2, the material application device, which is also preferably a powdering device, is not provided here in the vicinity of the blanket cylinder 4, but instead in the region of the transfer foil 1, that is to say in the region of the transport path of the transfer foil 1; to be precise, the material application device 7 is attached here in such a way that it applies the friction-reducing material to the rear side of the transfer foil, before the latter is guided through the transfer nip 3. Even if the material application device 7 is shown here without an extraction device 17, it is naturally possible and can also be provided that it is enclosed by an extraction device 17, in order also to avoid here that friction-reducing material passes from the region of the material application device into the air space within the printing unit.

In one alternative embodiment (not illustrated here), it is naturally also possible that material application devices 7 are provided both in the region of the transport path of the transfer foil 1 and in the region of the blanket cylinder 4.

For the case where the friction-reducing materials are applied to the rear side of the transfer foil 1, the latter is guided with these materials through the transfer nip 3. Here, the powder or the friction-reducing material then lies between the rear side of the transfer foil 1 and the blanket cylinder 4, and therefore reduces the friction between the blanket cylinder 4 and the transfer foil 1. It can occur here that friction-reducing material passes onto the blanket cylinder 4 and is collected here. In order to avoid, in a subsequent offset printing process, residues of the friction-reducing material passing onto the printing plate cylinder 9, a rubber blanket washing device 8 is also provided here, as has already been described in FIG. 1.

FIG. 3 shows the structure of a transfer foil 1 according to the invention. The transfer foil 1 is constructed from a carrier foil 11, to which first of all a transfer layer 12 is applied on the front side, which transfer layer 12 can also have an adhesion promoter 15 on its surface. The transfer layer 12 can be constructed in general in different ways; it serves for being applied to a printing material and highlighting a region. Here, this is the customary cold foil transfer process. The transfer foil 1 can be configured here in such a way that it has, as transfer layer 12, a release layer 13 and a metal layer 14, as in the example here which is shown. Here, the metal layer 14 can also comprise, in particular, a varnish which colors the metal, or the metal of this layer leads to a metallic gloss of a varnish layer.

In order then to reduce the friction between a blanket cylinder 4 and the transfer foil 1, there is provision for an antiadhesion layer to be provided on the rear side of the transfer foil 1, that is to say on the rear side of the carrier foil 11. This antiadhesion layer comprises friction-reducing material and ensures the above-described reduction in the friction between the transfer foil 1 and the blanket cylinder 4. This antiadhesion layer 16 can be, for example, a powder coating which is also applied, in particular, within a printing unit or a transfer unit directly onto the rear side of the transfer foil 1. There can also be provision for the transfer foil 1 to be manufactured in such a way that it already has a rear-side antiadhesion layer 16. This can then be, for example, PTFE or another friction-reducing layer.

As a result of the embodiments of the transfer units or the transfer foil which are shown here, it is possible to load the transfer foil 1 directly or a transfer cylinder surface, that is to say the surface of the blanket cylinder 4, with a friction-reducing material, such as powder, in order thus to reduce the friction between the transfer cylinder, that is to say the blanket cylinder 4, and the transfer foil 1. Adhesion between the blanket cylinder 4 and the transfer foil 1 is reduced as a result. The adhesion can no longer take place, as in the known prior art. Embossing of structures into the transfer foil 1 or the sheet 6 can also not occur as a result of the smooth surface of the applied material layer.

Here, there is provision, in particular, for a conventional rubber blanket to be used. This rubber blanket is fastened to the surface of the blanket cylinder 4 and should have substantially a smooth surface. In particular, it can also be elastic. It is also possible that although a smooth surface is preferred as surface of the blanket cylinder 4, this surface is intended to be as nonelastic and hard as possible. This can be achieved, for example, by a metal plate. For example, a rubber blanket of the company I.M.C. GmbH Munich having the commercial name Perfect Dot® MX can be used as standard rubber blanket. This has a preferred smooth surface structure and does not lead to any impairments, that is to say to any embossments in the sheet 6. High quality coating of the printed sheet 6 can therefore be carried out, the release of the transfer layer 12 of the transfer foil 1 being assisted in an improved manner as a result of the reduced frictional force between the blanket cylinder 4 and the transfer foil 1, and a smooth structure of the transfer layer being achieved on the sheet 6.

1. An apparatus for transferring a transfer layer from a front side of a carrier foil onto a printing material, the carrier foil and the transfer layer together forming a transfer foil, comprising:
at least one transfer unit for transferring the transfer layer onto the printing material;
said transfer unit including at least one transfer cylinder for transferring the transfer layer; and
said transfer unit including at least one material application device disposed to apply friction-reducing material onto at least one of said transfer cylinder and a reverse side of the carrier foil.

2. The apparatus according to claim 1, wherein said material application device is disposed in a region of said transfer cylinder, and configured to apply the friction-reducing material to a surface of said transfer cylinder.

3. The apparatus according to claim 1, wherein the transfer foil is moved along a transport path to said transfer cylinder and said material application device is disposed in a region of the transport path of the transfer foil, positioned upstream of the transfer cylinder in a transport direction, for applying the friction-reducing material to a rear side of the transfer foil.

4. The apparatus according to claim 1, wherein said material application device is formed in a cassette removably disposed in said transfer unit.

5. The apparatus according to claim 1, wherein said material application device has at least one of the elements selected from the group consisting of a bush, a cloth, and an inflating element configured to apply the friction-reducing material to at least one of a surface of the transfer cylinder and the reverse side of the carrier foil.

6. The apparatus according to claim 5, wherein said material application device includes an extraction device for extracting residues of the friction-reducing material.

7. The apparatus according to claim 1, which comprises a washing device for washing a surface of said transfer cylinder.

8. The apparatus according to claim 7, wherein said washing device is a rubber blanket washing device.

9. The apparatus according to claim 8, wherein said rubber blanket washing device includes a first washing agent circuit for a first washing agent for cleaning the surface of the transfer cylinder of residues of the friction-reducing material and a second washing agent circuit for a second washing agent for cleaning the surface of the transfer cylinder of ink residues of an offset printing process.

10. The apparatus according to claim 1, wherein said transfer unit is a unit selected from the group consisting of a printing unit, a varnishing unit, and a modular unit of a printing press.

11. The apparatus according to claim 10, wherein said transfer cylinder is a blanket cylinder, and a plate cylinder which is thrown onto said blanket cylinder for offset printing is provided without printing plates or in a thrown-off position from the blanket cylinder.

12. The apparatus according to claim 1, wherein the friction-reducing material is a fluid or a powder.

13. The apparatus according to claim 1, wherein the material application device is a powdering device of a printing press.

14. The apparatus according to claim 13, wherein the friction-reducing material is a powder having a grain size in a range from 10 μm to 90 μm.

15. The apparatus according to claim 14, wherein the powder has a grain size in a range from 15 μm to 35 μm.

16. A method of transferring a transfer layer from a front side of a carrier foil onto a printing material, the carrier foil and the transfer layer together forming a transfer foil, the method which comprises:
feeding the transfer foil to a transfer cylinder;
applying a friction-reducing material for reducing an adhesion between the carrier foil and a surface of the transfer cylinder to at least one of a rear side of the carrier foil and the surface of the transfer cylinder; and
transferring sections of the transfer layer onto the printing material by detaching the transfer layer in sections from the carrier foil.

17. The method according to claim 16, which comprises applying the friction-reducing material by way of a method selected from the group consisting of brushing on, spraying on, rolling on, doctoring on, and applying with a cloth.

18. The method according to claim 16, which comprises extracting air that is contaminated with friction-reducing material from a region of application.

19. The method according to claim 16, which comprises employing a blanket cylinder of a printing unit as the transfer cylinder.

20. The method according to claim 19, which comprises setting a plate cylinder that is associated with the blanket cylinder to be without contact with respect to the blanket cylinder, at least during the transferring step.

21. The method according to claim 20, which comprises throwing off the plate cylinder from the blanket cylinder and/or operating the plate cylinder without plates.

22. The method according to claim 16, which comprises cleaning the surface of the transfer cylinder of residues of the friction-reducing material by way of a washing device.

23. The method according to claim 22, which comprises washing with a rubber blanket washing device.

24. The method according to claim 16, which comprises cleaning the surface of the transfer cylinder of residues of the friction-reducing material with a first washing agent from a first washing agent circuit and cleaning the surface of the transfer cylinder of ink residues from an offset printing process with a second washing agent from a second washing agent circuit.

25. The method according to claim 16, which comprise employing a fluid or a powder as the friction-reducing material.

26. The method according to claim 16, which comprises applying the friction-reducing material with a powdering device of a printing press.

27. The method according to claim 25, which comprises employing silicone oil as the friction-reducing material.

28. The method according to claim 25, which comprises powdering with a powder selected from the group consisting of French chalk, mineral powder, and organic powder.

29. The method according to claim 25, which comprises powdering with a powder having a grain size in a range from 10 μm to 90 μm.

30. The method according to claim 29, wherein the powder has a grain size in a range from 15 μm to 35 μm.

31. A transfer foil, comprising:
a carrier foil having a front side and a rear side;
a release layer applied to the front side of said carrier foil, and a transfer layer carried on said release layer; and
a coating of friction-reducing material applied on said rear side of said carrier foil;
wherein said carrier foil and said transfer layer are configured for a transfer method in which the transfer layer, or segments thereof, is transferred from said carrier foil onto a printing material.

32. The transfer foil according to claim 31, wherein said friction-reducing material is PTFE or a powder coating.

33. The transfer foil according to claim 31, wherein said front side of said carrier foil carries said release layer, a metal layer, and a layer comprising an adhesion promoter for entering into a contacting connection with an adhesive layer on a printing material.
